(19) United States
(12) Patent Application Publication
(10) Pub. No.: US 2010/0100813 A1
(43) Pub. Date: Apr. 22, 2010

(54) DOCUMENT PROCESSING APPARATUS AND DOCUMENT PROCESSING METHOD

(75) Inventors: Seiji Saito, Shizuoka-ken (JP); Norimasa Ariga, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/575,773

(22) Filed: Oct. 8, 2009

Related U.S. Application Data
(60) Provisional application No. 61/106,883, filed on Oct. 20, 2008.
(60) Provisional application No. 61/107,499, filed on Oct. 22, 2008.

(51) Int. Cl. G06F 17/00

(52) U.S. Cl. 715/255

(57) ABSTRACT

A document processing apparatus which corrects object data included in a document includes a document file input section configured to input a document file including metadata and object data, an object information acquisition section configured to acquire the object data from the document file, a document information acquisition section configured to acquire the metadata added to the document, a document information analysis section configured to execute, based on the obtained metadata, at least one type of process application determination to determine whether a correction is applied or not applied to the object data, an application process determination section configured to determine, based on a result of at least the one type of executed process application determination, whether the correction is applied or not applied to the object data, and a process execution section configured to execute the correction on the object data based on a determined result.

### CROSS-REFERENCE TO RELATED APPLICATION

This application is based upon and claims the benefit of U.S. Provisional Applications 61/106,883, filed on Oct. 20, 2008; and 61/107,499, filed on Oct. 22, 2008.

### TECHNICAL FIELD

Described herein relates to a technique to correct an object included in a document.

### BACKGROUND

There is proposed a technique to correct an image photographed by a digital camera or the like.

In a technique disclosed in JP-A-2002-232728, an image portion is extracted from a document file, and a histogram is generated based on image data of the image portion. Next, the generated histogram is analyzed to calculate a feature quantity, and it is determined how correction is performed. The determined correction is automatically performed for the image portion.

In a technique disclosed in JP-A-2003-234916, a keyword or the like is inputted by using a touch panel, a keyboard, a voice input device or the like. A correction region, a correction unit, a correction quantity and the like are selected from the inputted keyword, and a correction reflecting the selected result is executed.

### SUMMARY

Described herein relates to a document processing apparatus which corrects object data included in a document, comprising: a document file input section configured to input a document file including metadata and object data; an object information acquisition section configured to acquire the object data from the document file; a document information acquisition section configured to acquire the metadata added to the document; a document information analysis section configured to execute, based on the metadata obtained by the document information acquisition section, at least one type of process application determination to determine whether a correction is applied or not applied to the object data; an application process determination section configured to determine, based on a result of at least the one type of process application determination executed by the document information analysis section, whether the correction is applied or not applied to the object data; and a process execution section configured to execute the correction on the object data based on a result determined by the application process determination section.

Described herein relates to a document processing method for correcting object data included in a document, the document processing method including: inputting a document file including metadata and object data, acquiring the object data from the document file, acquiring the metadata added to the document, executing, based on the obtained metadata, at least one type of process application determination to determine whether a correction is applied or not applied to the object data, determining, based on a result of at least the one type of process application determination executed, whether the correction is applied or not applied to the object data, and executing the correction to the object data based on a determined result.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a structure of a document processing system including a document processing apparatus of a first embodiment.

FIG. 2 is a view showing document data.

FIG. 3 is a view showing a structure of document data handled by the document processing apparatus of the first embodiment.

FIG. 4 is a view exemplifying metadata.

FIG. 5 is a flowchart showing a procedure to determine, based on attribute data, whether an object correction process is applied or not applied.

FIG. 6 is a view showing attribute data extracted from metadata.

FIG. 7 is a flowchart showing a procedure to determine, based on a coordinate position, whether the object correction is applied or not applied.

FIG. 8 is a view showing coordinate position data extracted from metadata.

FIG. 9 is a view for explaining a method of determining, based on the coordinate position data, whether the object correction is applied or not applied.

FIG. 10 is a flowchart showing a procedure to determine, based on an object size, whether the object correction is applied or not applied.

FIG. 11 is a view showing an example of an output result in a case where a determination process based on template information is executed.

FIG. 12 is a view showing an example of an output result in a case where plural determination processes are executed.

FIG. 13 is a view showing a final determination result using a weight.

FIG. 14 is a view showing a final determination result using a logical sum.

FIG. 15 is a view showing a final determination result using a logical product.

FIG. 16 is a view showing a structure of a document processing system including a document processing apparatus of a second embodiment.

FIG. 17 is a view showing a density histogram.

FIG. 18 is a view in which an image of object data is divided into plural blocks.

FIG. 19 is a view showing a structure of a document processing system including a document processing apparatus of a third embodiment.

FIG. 20 is a view showing a setting screen of a maintenance specifying section.

FIG. 21 is a view showing an example of an image including a bright portion and a dark portion.

FIG. 22 is a schematic block diagram showing a structure of an image processing system including an image processing apparatus of a fourth embodiment.

FIG. 23 is a flowchart showing a process procedure of the image processing apparatus.

FIG. 24 is a flowchart showing a procedure of obtaining a brightness estimated value using DCT.

FIG. 25 is a view showing an example of a low frequency band when a DCT window is divided into 8×8 blocks.

FIG. 26 is a view showing a characteristic of a sigmoid function.

### DETAILED DESCRIPTION

### First Embodiment

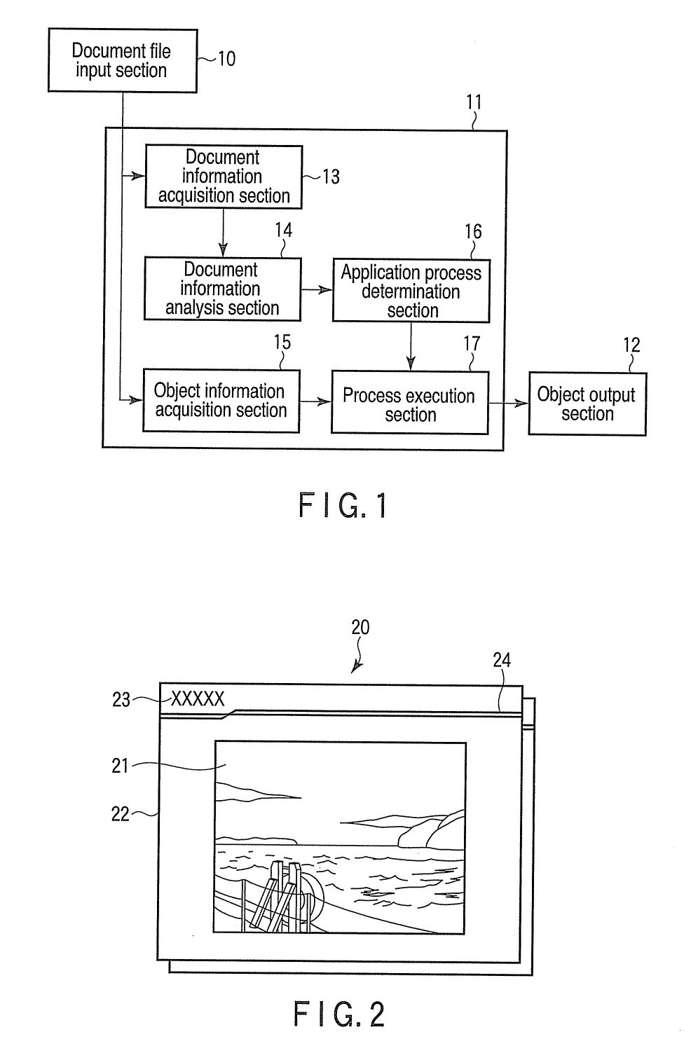

FIG. 1 is a view showing a structure of a document processing system including a document processing apparatus of a first embodiment.

The document processing system includes a document file input section 10, a document processing apparatus 11 and an object output section 12. The document processing apparatus 11 includes a document information acquisition section 13, a document information analysis section 14, an object information acquisition section 15, an application process determination section 16, and a process execution section 17.

The document file input section 10 acquires document data.

FIG. 2 is a view showing document data 20. The document data 20 shown in FIG. 2 includes an image 21 representing a marine scene, an image 22 representing an outer frame, an image 23 representing a logo mark, and an image 24 representing a decoration line. The document data 20 includes two pages.

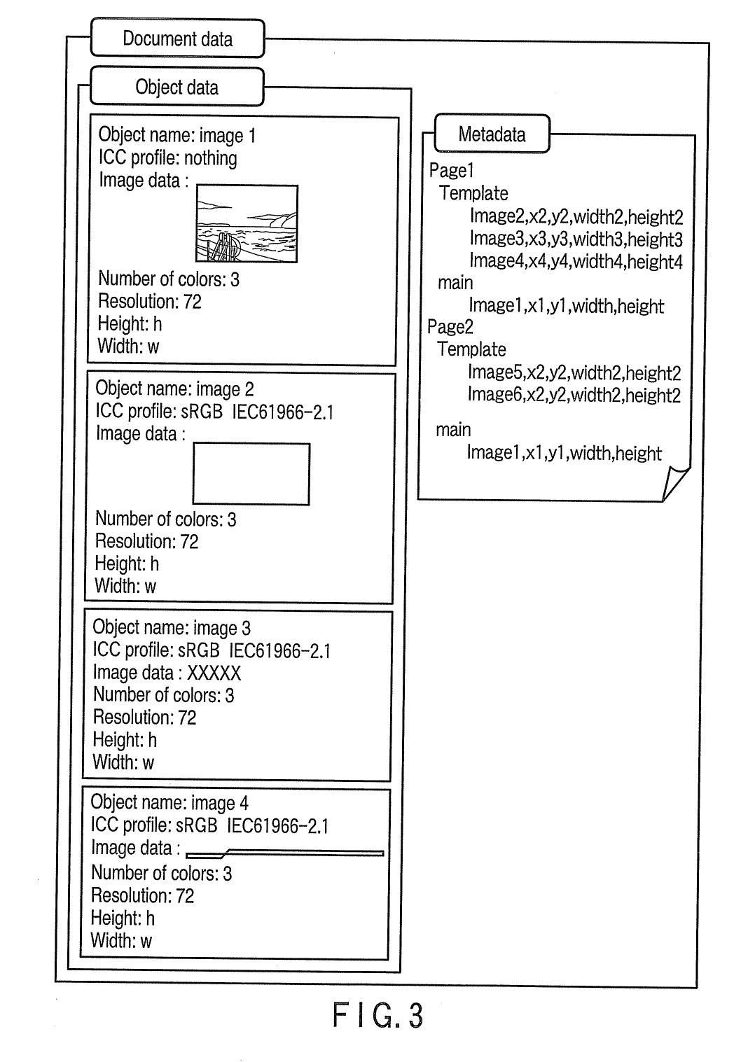

FIG. 3 is a view showing a structure of the document data handled by the document processing apparatus of the first embodiment.

As shown in FIG. 3, the document data includes object data and metadata. Here, the object data is the data concerning the specification of registered objects. As an example of the object data, there are enumerated image bitmap data, data of image width and height, resolution information, color space, ICC profile information, Exif data and the like.

The metadata is the data describing a state where the object data is rendered (outputted).

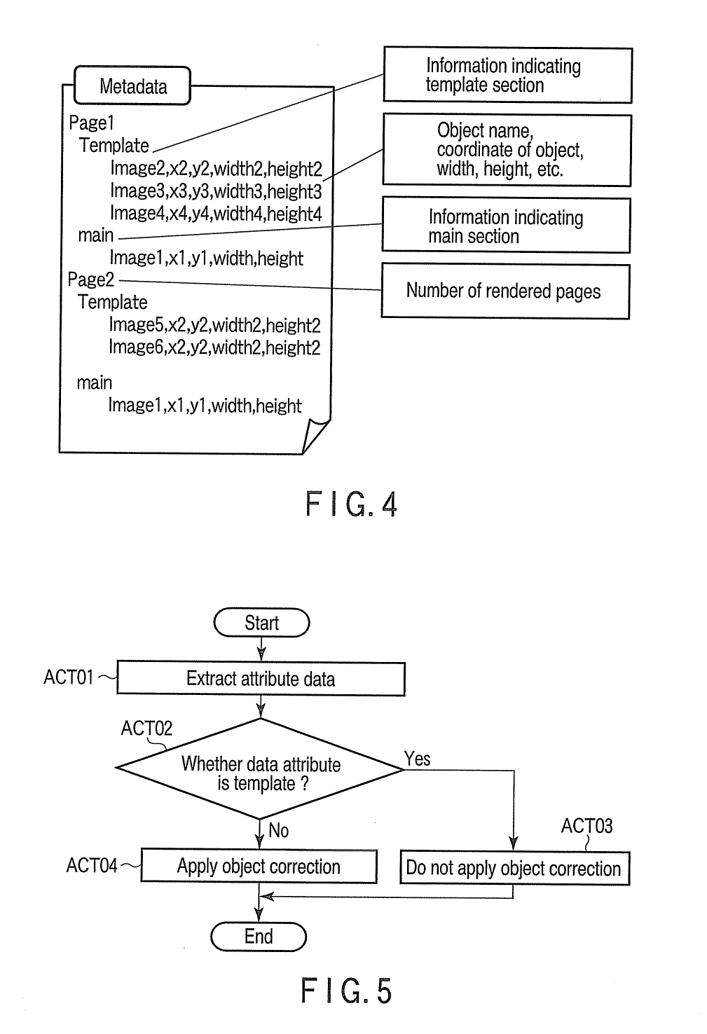

FIG. 4 is a view exemplifying the metadata. The metadata includes an object rendering page, an object name, a data attribute (main data, template data), template information (header and footer, style sheet, design template, etc.), object rendering position information, an object rendering resolution, an object rendering size, and the like.

As an example of document data handled by the document processing apparatus of the first embodiment, there are enumerated an XPS file, a PPT file, a Word file, a pdf file, a file generated by Postscript, and the like.

The document data acquired by the document file input section 10 is, for example, data acquired through an output application of a PC (Personal Computer) provided in the outside, or file data generated from image data read by a scanner.

The document information acquisition section 13 extracts the metadata from the document data acquired by the document file input section 10. The document information analysis section 14 determines, based on each of plural references, whether or not a correction process of an object is performed. The application process determination section 16 performs final determination of whether or not the object correction process is applied to each object based on plural results obtained from the document information analysis section 14.

The object information acquisition section 15 acquires the object data from the document data acquired by the document file input section 10. The process execution section 17 performs the object correction process on the object for which the application process determination section 16 determines that the object correction is to be applied, and then outputs it to the object output section 12.

Next, a description will be given to a determination method in which the document information analysis section 14 determines whether or not the correction process of an object is performed. In the determination method, as stated above, there are plural references using the metadata, and for example, there are a method of using template information as attribute data, a method of using coordinate position information, a method of using an image size, and the like.

FIG. 5 is a flowchart showing a procedure of determining, based on the attribute data, whether the object correction process is applied or not applied. This procedure is repeatedly executed for each of the objects.

At Act 01, the document information analysis section 14 extracts the attribute data of an object.

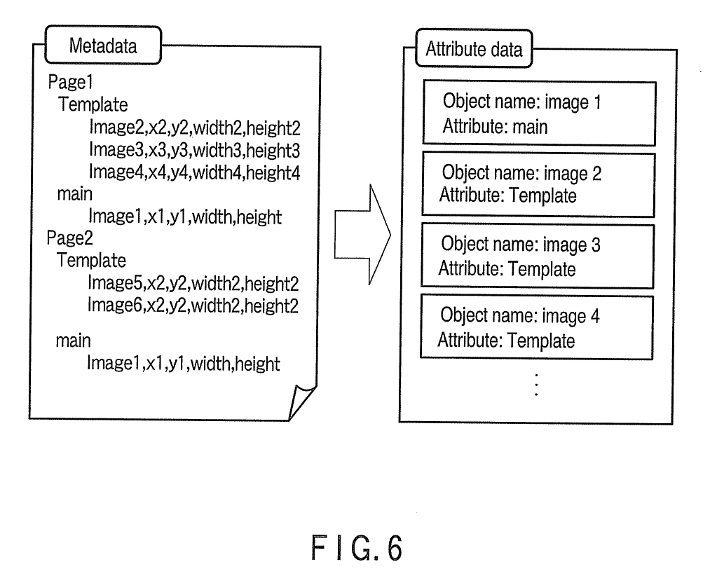

FIG. 6 is a view showing the attribute data extracted from the metadata. For example, the attribute data of an object name Image 1 representing a marine scene is “main”, and the attribute data of object names Image 2, Image 3 and Image 4 expressing an outer frame, a logo mark, and a decoration line are “Template”.

When in the case of Yes at Act 02 of FIG. 5, that is, when the data attribute is the template, at Act 03, the object correction is not applied. In the case of No at Act 02, that is, when the data attribute is not the template, at Act 04, the object correction is applied.

In accordance with this flow, even if the user does not specify, the object correction can be automatically made not to be applied to the object used for the template which does not generally require the correction. Incidentally, with respect to whether the object correction is applied or not applied, the after-mentioned document information analysis section 14 refers to this result and finally determines whether or not the correction process is applied.

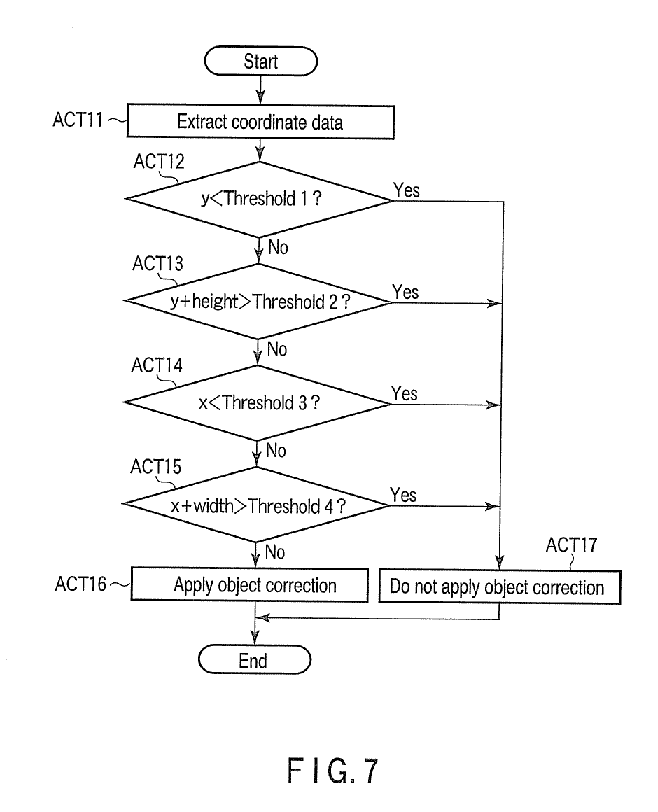

FIG. 7 is a flowchart showing a procedure of determining, based on a coordinate position, whether the object correction is applied or not applied.

At Act 11, the document information analysis section 14 extracts coordinate position data of an object from the metadata obtained by the document information acquisition section 13.

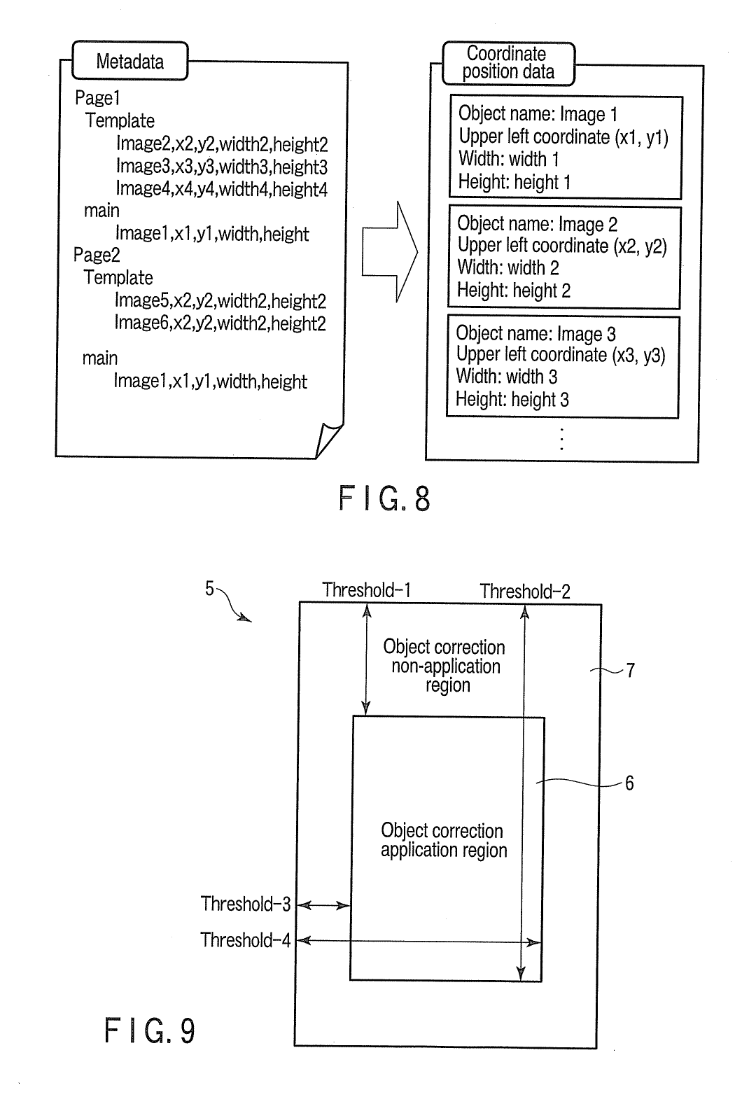

FIG. 8 is a view showing the coordinate position data extracted from the metadata. The coordinate position data includes an upper left coordinate (x, y), a width (width), and a height (height). For example, the coordinate position data of an object name Image 1 has the upper left coordinate (x1, y1), the width=width 1 and the height=height 1.

FIG. 9 is a view for explaining a method of determining, based on the coordinate position data, whether the object correction is applied or not applied. FIG. 9 shows the whole one page outputted. When an object exists only in an object correction application region 6 of FIG. 9, the correction is applied to the object. However, when an object exists in an object correction non-application region 7, the correction is not applied to the object.

At Act 12 of FIG. 7, it is checked whether or not the upper end coordinate y of an object is smaller than Threshold 1. Here, the upper left point of a rectangle 5 shown in FIG. 9 is the original (0, 0) of the coordinate, x increase in the right direction, and y increases in the downward direction.

In the case of Yes at Act 12, since the upper end coordinate y of the object belongs to the object correction non-application region 7, at Act 17, the object correction is not applied.

In the case of No at Act 12, since the upper end coordinate y of the object belongs to the object correction application region 6, at Act 13, it is checked whether or not the lower end coordinate (y+height) of the object is larger than Threshold 2.

In the case of Yes at Act 13, since the lower end coordinate (y+height) of the object belongs to the object correction non-application region 7, at Act 17, the object correction is not applied.

In the case of No at Act 13, since the lower end coordinate (y+height) of the object belongs to the object correction application region 6, at Act 14, it is checked whether or not the left end coordinate x of the object is smaller than Threshold 3.

In the case of Yes at Act 14, since the left end coordinate x of the object belongs to the object correction non-application region 7, at Act 17, the object correction is not applied.

In the case of No at Act 14, since the left end coordinate x of the object belongs to the object correction application region 6, at Act 15, it is checked whether or not the right end coordinate (x+width) of the object is larger than Threshold 4.

In the case of Yes at Act 15, since the right end coordinate (x+width) of the object belongs to the object correction non-application region 7, at Act 17, the object correction is not applied.

In the case of No at Act 15, since the right end coordinate (x+width) of the object belongs to the object correction application region 6, at Act 16, the object correction is applied.

In the flow shown in FIG. 7, when the object is contained in the correction application region 6, the correction is applied, and when not so, the correction is not applied.

A specific example of the determination using the flow of FIG. 7 will be described. It is assumed that coordinate data of an object 1 is x=0, y=0, width=10 and height=10, coordinate data of an object 2 is x=100, y=100, width=100 and height=100, and coordinate data of an object 3 is x=1000, y=1000, width=250 and height=100. Threshold 1, Threshold 2, Threshold 3 and Threshold 4 are respectively 50, 1500, 30 and 1200.

Since the value of y of the object 1 is smaller than Threshold 1, it is determined that the object correction process of the input object 1 is not applied. It is determined that the object correction process of the input object 2 is applied. Since the result of addition of x and width of the object 3 exceeds the value of Threshold 4, it is determined that the object correction process of the input object 3 is not applied.

By performing the foregoing determination process, even if the user does not specify, the object correction can be automatically made not to be applied to an object positioned at the header portion or the footer portion, and an object such as a frame to which a design is applied.

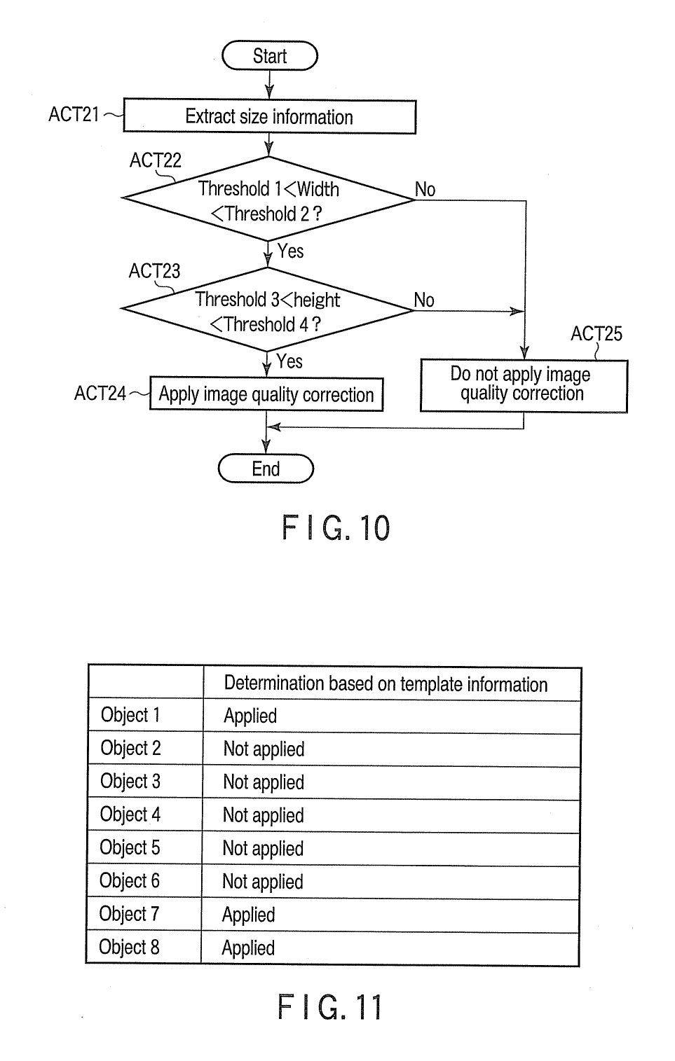

FIG. 10 is a flowchart showing a procedure of determining, based on the object size, whether the object correction is applied or not applied.

At Act 21, the document information analysis section 14 extracts the size information of an object from the metadata obtained by the document information acquisition section 13. The size information includes a width (width) and a height (height). For example, the size information of the object name Image 1 shown in FIG. 8 is the width=width 1 and the height=height 1.

When the extracted size information of the object is not larger than a threshold indicating a previously determined minimum object size, or is not smaller than a threshold indicating a previously determined maximum object size, the object correction is not applied.

At Act 22 of FIG. 10, it is checked whether the width of the object is larger than Threshold 1 and smaller than Threshold 2.

In the case of No at Act 22, since the width size of the object is not within the range of the previously determined object width size, at Act 25, the object correction is not applied.

In the case of Yes at Act 22, since the width size of the object is within the range of the previously determined object width size, at Act 23, it is checked whether the height of the object is larger than Threshold 3 and smaller than Threshold 4.

In the case of No at Act 23, since the height size of the object is not within the range of the previously determined object height size, at Act 25, the object correction is not applied.

In the case of Yes at Act 23, since the height size of the object is within the range of the previously determined object height size, at Act 24, the object correction is applied.

A specific example of the determination using the flow of FIG. 10 will be described. The rendering size of an input object 1 is 10×10, the rendering size of an input object 2 is 100×100, and the rendering size of an input object 3 is 100×2000. The width minimum object size (Threshold 1 in FIG. 10), the width maximum object size (Threshold 2 in FIG. 10), the height minimum object size (Threshold 3 in FIG. 10), and the height width maximum object size (Threshold 4 in FIG. 10), which are thresholds, are respectively 20, 1500, 20 and 1500.

In this case, although the input object 1 has width=10, since the width minimum threshold is 20, the object correction process is not applied. With respect to the input object 2, since the values of the width and the height are within the thresholds, the correction process is applied. Although the input object 3 has height=2000, since the height maximum threshold is 1500, the object correction process is not applied.

By performing the foregoing determination process, with respect to an object which is so small that the effect of the object correction process can not be discriminated, the object correction process can be automatically made not to be applied. Besides, with respect to a large object requiring a long process time when the object process is performed, the object correction process can be automatically made not to be applied even if the specification is not performed.

The document information analysis section 14 may execute only one of the foregoing processes and may output the result to the application process determination section 16, or may execute the foregoing plural processes and may output the plural determination results to the application process determination section 16.

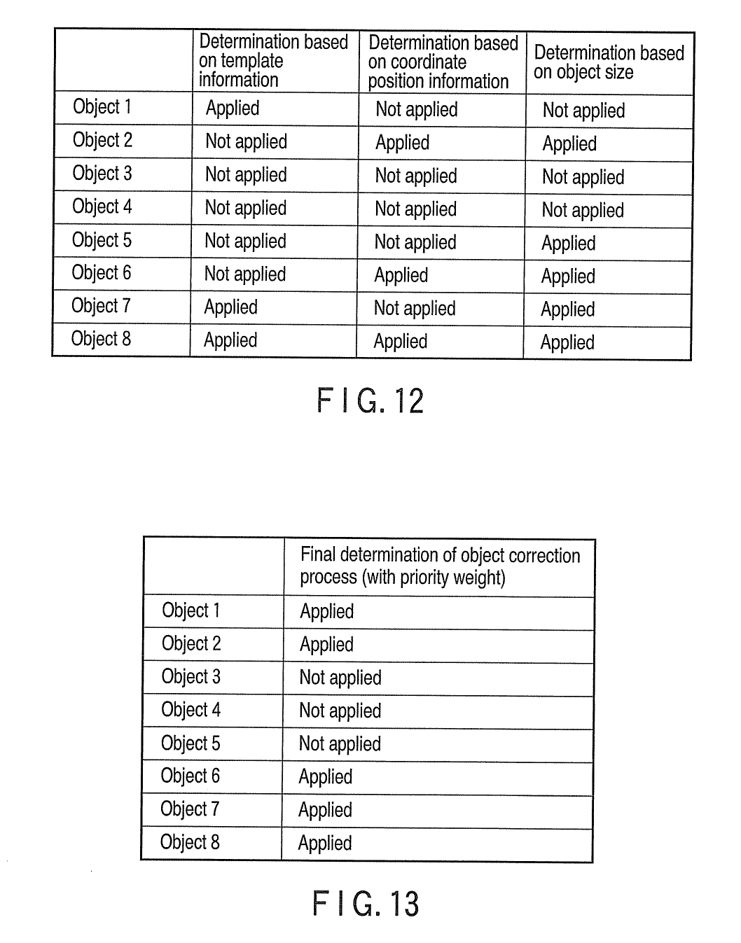

FIG. 11 is a view showing an example of an output result when the determination process based on the template information is executed. FIG. 12 is a view showing an example of output results when the plural determination processes are executed.

The application process determination section 16 performs, based on the results outputted by the document information analysis section 14, the final determination of whether or not the object correction process is applied for each of the objects. When the plural determination results are obtained for one object, the document information analysis section 14 can use various methods as the final determination method. For example, there are enumerated a method of giving a weight of determination priority to each of the determination results, a method of using a logical sum, a method of using a logical product, and the like. The application process determination section 16 outputs the final determination result to the process execution section 17.

Next, the determination method using weighting will be described. It is assumed that the determination results shown in FIG. 12 are the results outputted by the document information analysis section 14, and a case where the determination result is “applied” is replaced by “1”, and a case where “not applied” is replaced by “0”, and the calculation is performed. It is assumed that the weight applied to the determination based on the template information is 0.5, the weight applied to the determination based on the coordinate position information is 0.3, and the weight applied to the determination based on the object size is 0.2. When the total value of the values weighted in this way is 0.5 or more, it is finally determined that the object correction process is applied.

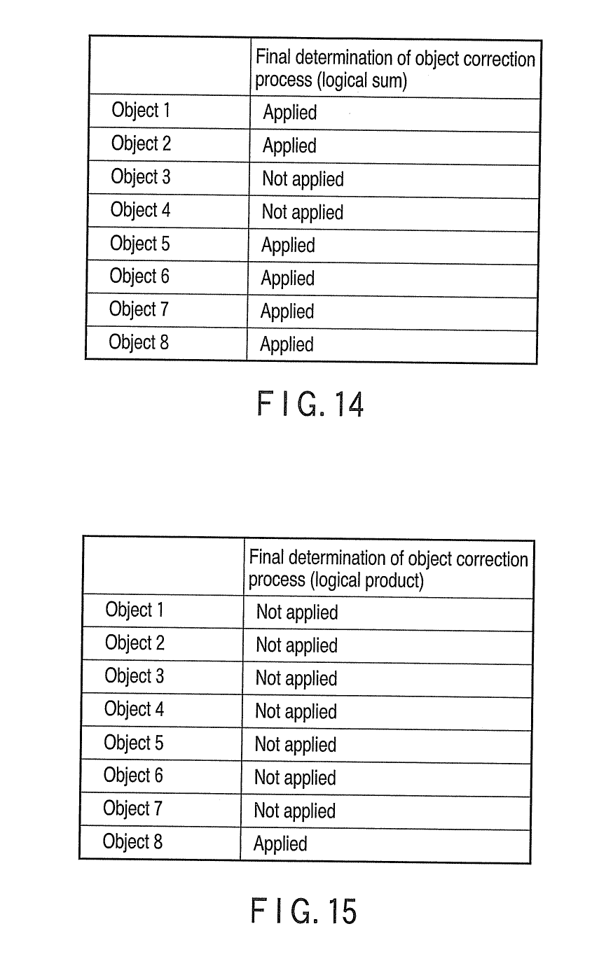

FIG. 13 is a view showing the final determination result using the weight. Besides, as stated above, the case where the determination result is “applied” is replaced by “1”, and the case of “not applied” is replaced by “0”, and the logical sum or the logical product can be calculated. FIG. 14 is a view showing the final determination result using the logical sum. FIG. 15 is a view showing the final determination result using the logical product.

The process execution section 17 does not perform the object correction process on the object for which the application process determination section 16 determines that the object correction is not to be applied, and the process execution section performs the object correction process on the object for which the application process determination section 16 determines that the object correction is to be applied. Then, the process execution section 17 outputs the object subjected to the object correction process and the object not subjected to the object correction process to the object output section 12. The object output section 12 edits the object data based on the metadata and outputs it.

Incidentally, as an example of the object correction, an image quality correction can be mentioned when the object is an image. As an example of the image quality correction, there can be mentioned a correction method (JP-A-2002-232728) in which a histogram or the like is used to perform analysis, and the correction is automatically performed. Besides, there can be mentioned a correction method (Japanese Patent Application No. 11-338827) in which when a character is included in an object like a graph, color conversion is performed so as to make the character easily visible and rendering is performed. The image quality correction includes, for example, contrast correction, backlight correction, saturation correction, facial color correction and the like. A well-known technique may be applied to these image quality corrections.

As described above, an object for which it is not necessary to perform the object correction process can be automatically determined by determining, based on the metadata, whether or not the object correction is performed. As a result, the user's specifying operation to cause the object correction process not to be applied can be eased.

Incidentally, in this embodiment, the description is given to the embodiment in which the object in the document file is subjected to the correction process, and the rendering output (printing, displaying, etc.) is performed. However, the invention is not limited to this embodiment, but can also be applied to application software in which an object in a document file is corrected, and then, the corrected object is stored (replaced) in the document file.

### Second Embodiment

A second embodiment is different from the first embodiment in that whether or not an object correction is performed is determined by using an image feature quantity in addition to metadata.

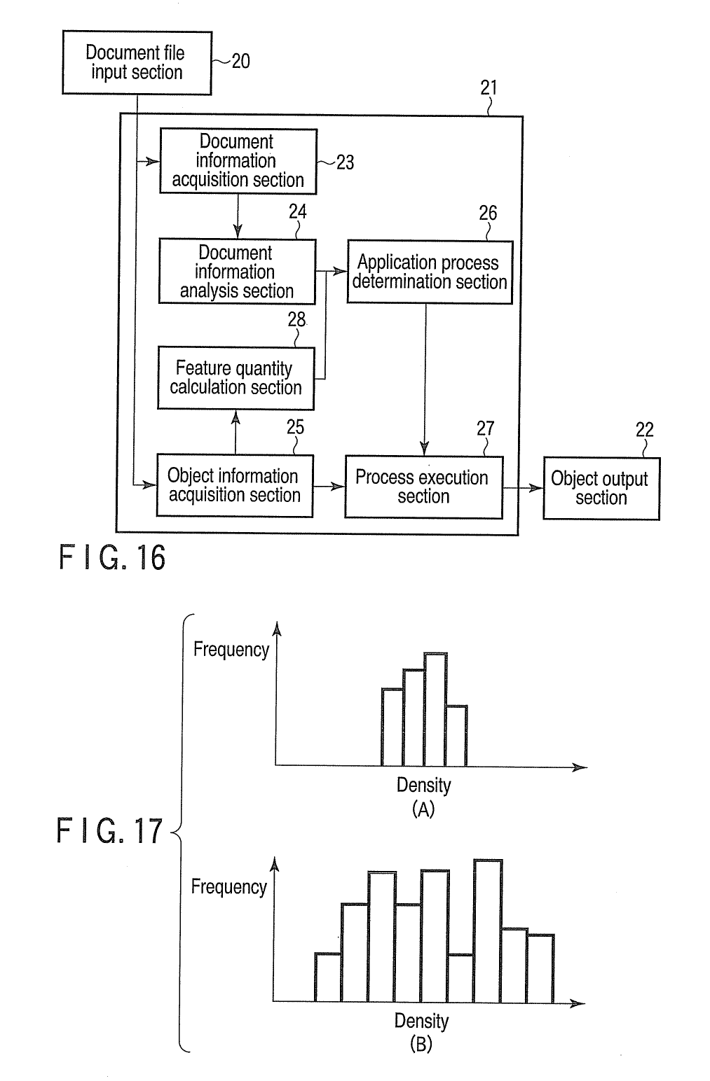

FIG. 16 is a view showing a structure of a document processing system including a document processing apparatus of the second embodiment.

The document processing system includes a document file input section 20, a document processing apparatus 21 and an object output section 22. The document processing apparatus 21 includes a document information acquisition section 23, a document information analysis section 24, an object information acquisition section 25, an application process determination section 26, a process execution section 27 and a feature quantity calculation section 28.

Since the document file input section 20, the document information acquisition section 23, and the document information analysis section 24 are respectively the same as the document file input section 10, the document information acquisition section 13, and the document information analysis section 14 of the first embodiment, their detailed description is omitted.

The object information acquisition section 25 acquires object data from document data acquired by the document file input section 20. The object information acquisition section 25 outputs the object data to the process execution section 27 and the feature quantity calculation section 28.

The feature quantity calculation section 28 calculates a feature quantity for determining an image quality correction amount from the object data outputted by the object information acquisition section 25, and it is determined whether the image quality correction is applied or not applied.

As an example of calculation of a feature quantity, there is a method (JP-A-2002-232728) in which an analysis is made using a histogram or the like from object data. Besides, there is known a method in which an image is divided into plural blocks, and an analysis is made using the luminance of each of the blocks.

A description will be given to a method in which a histogram is used to determine whether an image quality correction is applied or not applied. FIGS. 17A and 17B are views each showing a density histogram in which the horizontal axis indicates the density and the vertical axis indicates the appearance frequency of the density. In FIG. 17A, the density range of the object data is narrow. Accordingly, it is determined that the contrast correction is necessary for the object data, and it is determined that the image quality correction is applied. In FIG. 17B, the density range of the object data is wide. Accordingly, it is determined that the contrast correction is not necessary for the object data, and it is determined that the image quality correction is not applied.

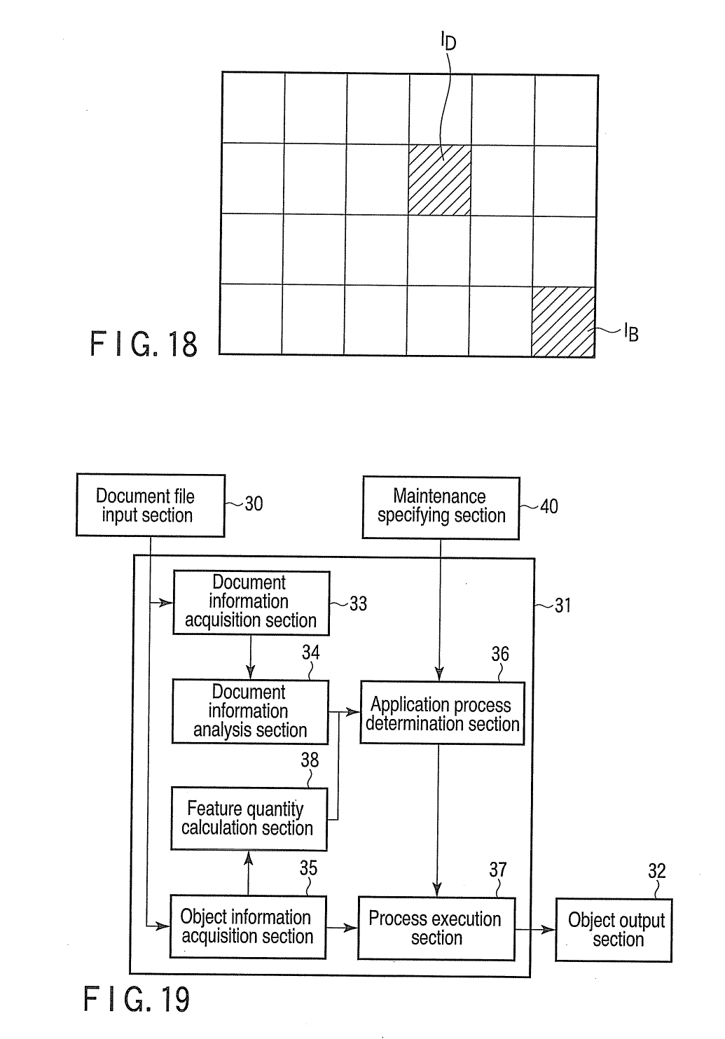

A description will be given to a method in which the luminance of a block is used to determine whether the image quality correction is applied or not applied. FIG. 18 is a view in which an image of object data is divided into plural blocks. In the plural blocks, an average luminance value I_{D} of center blocks and an average luminance value I_{B} of peripheral blocks are calculated. Then, a difference between both the luminance values is compared with a threshold T_{H}. In the case of I_{B}−I_{D}≧T_{H}, it is determined that the backlight correction is necessary, and it is determined that the backlight correction is applied. In the case of I_{B}−I_{D}<T_{H}, it is determined that the backlight correction is not necessary, and it is determined that the backlight correction is not applied.

Similarly, a well-known technique is used, and it is determined whether, for example, saturation correction or facial color correction is applied or not applied.

The feature quantity calculation section 28 outputs the calculated image quality correction parameter group and the determination result of whether the image quality correction is applied or not applied to the application process determination section 26.

The application process determination section 26 performs the final determination of whether or not the object correction process is applied to each object based on the results obtained from the document information analysis section 24 and the feature quantity calculation section 28.

At this time, the application process determination section 26 applies the determination method described in the first embodiment to an object other than an object for which the feature quantity calculation section 28 determines that the image quality correction process is not applied. For example, the method of giving the weight of determination priority to each determination result, the method of using the logical sum, or the method of using the logical product is applied. The application process determination section 26 outputs the final determination result and the image quality correction parameter group to the process execution section 27.

The process execution section 27 executes the object correction process to the object for which the application process determination section 26 determines that the object correction is to be applied. At this time, the correction is executed by using the image quality correction parameter calculated by the feature quantity calculation section 28, so that the process can be made effective.

The process execution section 27 outputs the object subjected to the object correction process and the object not subjected to the object correction process to the object output section 22. The object output section 22 edits the object data based on the metadata and outputs it.

As described above, it is determined, based on the metadata and the feature quantity, whether or not the object correction is performed, and the object which does not require the object correction process can be automatically determined. As a result, the user's specifying operation to cause the object correction process not to be applied can be eased.

Besides, in addition to this operation, the feature quantity calculation section 28 previously calculates the image quality correction parameter, and the image quality correction process can be made effective.

### Third Embodiment

A third embodiment is different from the second embodiment in that the user can specify that the object correction is not to be applied.

FIG. 19 is a view showing a structure of a document processing system including a document processing apparatus of the third embodiment.

The document processing system includes a document file input section 30, a document processing apparatus 31, a maintenance specifying section 40 and an object output section 32. The document processing apparatus 31 includes a document information acquisition section 33, a document information analysis section 34, an object information acquisition section 35, an application process determination section 36, a process execution section 37 and a feature quantity calculation section 38.

The maintenance specifying section 40 specifies, for the document processing apparatus, an object for which the object correction is not performed. The application process determination section 36 performs final determination to fulfill the instruction from the maintenance specifying section 40.

Incidentally, a structure other than the application process determination section 36 and the maintenance specifying section 40 is the same as the second embodiment, its detail description is omitted.

In the third embodiment, the maintenance specifying section 40 corresponds to a printer driver of a personal computer (PC) as an external apparatus. However, no limitation is made to this embodiment, and the maintenance specifying section 40 may be a control panel connected to the document processing apparatus 31.

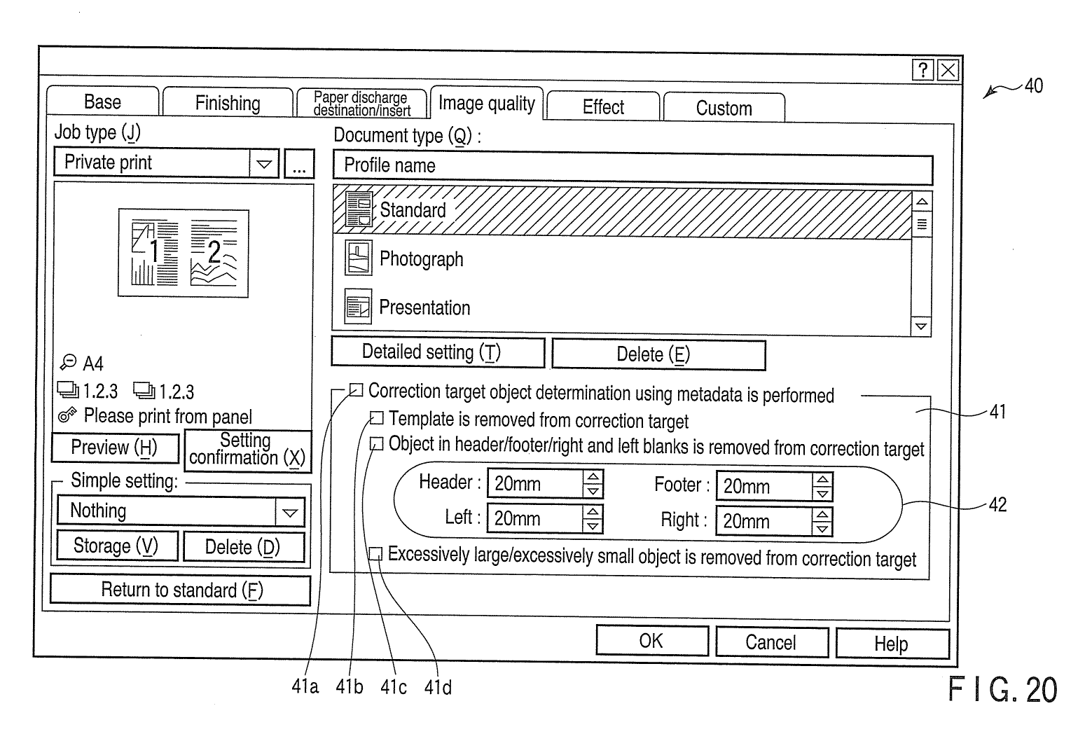

FIG. 20 is a view showing a setting screen of the maintenance specifying section 40.

Each check box of a check box column 41 provided in the maintenance specifying section 40 is checked, and it is possible to specify that the object correction is not applied.

When a check box 41a of “correction object determination using metadata is performed” is checked, the setting is inputted to the application process determination section 36. The application process determination section 36 executes the final determination based on plural determination process results using the metadata as described in the first embodiment.

When a check box 41b of “template is removed from correction target” is further checked in the state where the check box 41a is checked, the setting is inputted to the application process determination section 36. The application process determination section 36 removes an object, for which it is determined based on the template information that the object correction is applied (FIG. 5), from the correction target.

When a check box 41c of “object in header/footer/right and left blanks is removed from correction target” is further checked in the state where the check box 41a is checked, and when data is set in a numerical value input column 42, the setting data is inputted to the application process determination section 36. The set data are values corresponding to Threshold 1 to Threshold 4 of FIG. 9, and the document information analysis section 34 also refers to the values. The application process determination section 36 removes an object, for which it is determined based on the coordinate position information that the object correction is applied (FIG. 7), from the correction target.

When a check box 41d of “excessively large/excessively small object is removed from correction target” is further checked in the state where the check box 41a is checked, the setting is inputted to the application process determination section 36. The application process determination section 36 removes an object, for which it is determined based on the object size that the object correction is applied (FIG. 10), from the correction target.

Incidentally, two or more of the check boxes 41b to 41d can be checked.

The application process determination section 36 performs the final determination of whether or not the object correction process is applied to each object based on the results obtained from the document information analysis section 34, the feature quantity calculation section 38 and the maintenance specifying section 40.

At this time, the application process determination section 36 removes the object for which the maintenance specifying section 40 determines that the object correction process is not applied, and further removes the object for which the feature quantity calculation section 38 determines that the object correction process is not applied. Then, the determination method described in the first embodiment is applied to the remaining objects. For example, the method of giving the weight of determination priority to each determination result, the method of using the logical sum, or the method of using the logical product is applied. The application process determination section 36 outputs the final determination result and the image quality correction parameter group to the process execution section 37.

Incidentally, the contents which can be set by the maintenance specifying section 40 are not limited to the items shown in FIG. 20. For example, it is possible to perform setting such that information of Pantone color as a color sample is specified, and the color is not corrected. Besides, it is possible to perform setting such that information of a log mark is specified, and an object representing the log mark is not corrected. Further, it is possible to perform setting such that information of a specific character string is specified, and an object representing the character string is not corrected.

As described above, in addition to the effect of the second embodiment, since the object which is not subjected to the object correction can be specified based on the features such as the attribute, color, size and position, the user's specifying operation to cause the object correction process not to be applied can be further eased.

Incidentally, in the third embodiment, although the maintenance specifying section 40 is provided in the second embodiment, the maintenance specifying section 40 may be provided in the first embodiment. In addition to the effect of the first embodiment, the user's specifying operation to cause the object correction process not to be applied can be further eased.

According to the respective embodiments described above, the user's specifying operation can be eased by controlling the processing method to the object by using the object position information included in the sentence file or the metadata information such as the application template.

Besides, the object which is not subjected to the object correction can be specified based on the attribute, color, size, position information and the like, and the automatic correction can be applied to a portion to be corrected. In the related art, all colors to be maintained and all regions where color is to be maintained must be specified. However, in the embodiments, the automatic image quality correction can be more easily applied.

### Fourth Embodiment

In recent years, a digital camera, a portable camera and the like become remarkably popular. On the other hand, since an image photographed by those apparatuses is limited to a range narrower than an actual dynamic range, there is a case where gradation in a dark portion is not sufficient.

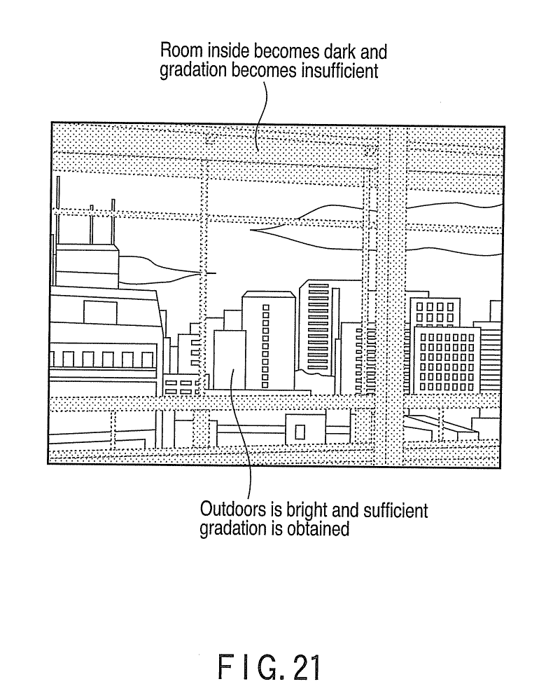

FIG. 21 shows an example of an image including a bright portion and a dark portion. It can be confirmed that an outdoor scene is bright and the gradation is sufficient, however, an indoor subject is dark and the gradation is not sufficient.

In order to improve such a defect, there is disclosed a technique to correct an image photographed by a digital camera or the like.

In the technique disclosed in JP-A-2002-209115, an image quality is improved by using a histogram. The histogram representing the distribution of luminance values is generated from image data. Next, the image is corrected so that the histogram is equalized. By this, the image corresponding to the appearance frequency of the luminance value is generated.

In the technique proposed in JP-A-2006-114005 or JP-A-2001-313844, the luminance value of an input image is used for each local region and a lightness correction is performed.

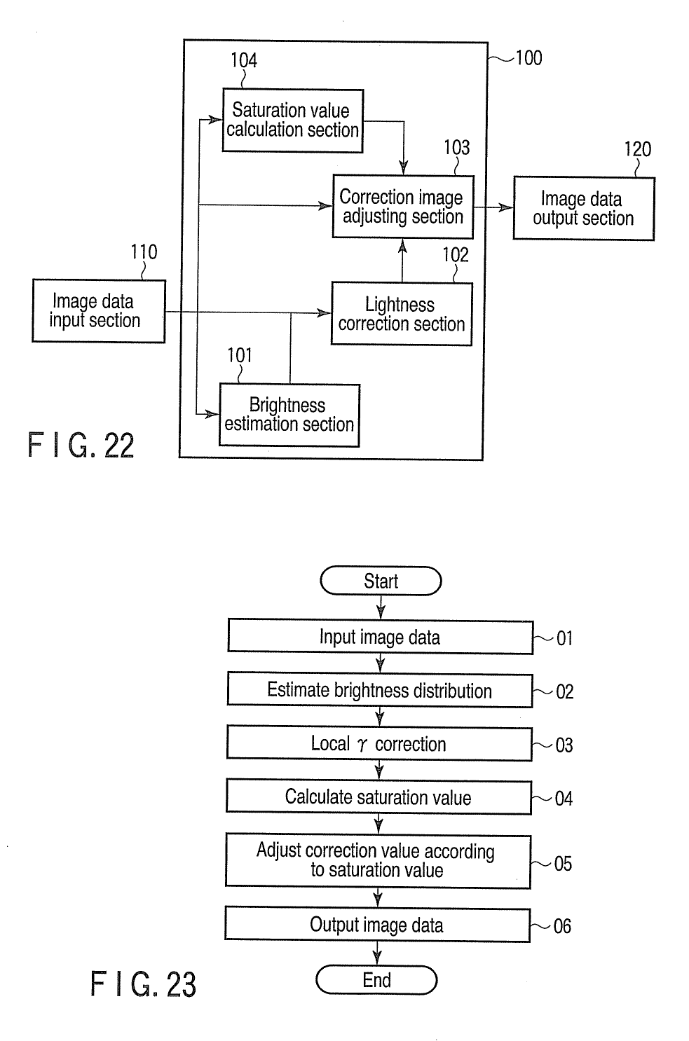

FIG. 22 is a schematic block diagram showing a structure of an image processing system including an image processing apparatus of a fourth embodiment.

The image processing system includes an image data input section 110, an image processing apparatus 100 and an image data output section 120. The image processing apparatus 100 includes a brightness estimation section 101, a lightness correction section 102, a correction image adjusting section 103 and a saturation value calculation section 104.

The image data input section 110 is a camera, a scanner or the like to input a document image and to generate image data. The brightness estimation section 101 calculates a brightness estimated value of a target pixel of the input image data. The lightness correction section 102 calculates a local lightness correction value based on the brightness estimated value and the pixel value of the input image data and corrects the lightness.

The saturation value calculation section 104 calculates a saturation value of the target pixel of the image data. The correction image adjusting section 103 uses the calculated saturation value and the calculated local lightness correction value to correct the pixel value of the input image data, and calculates the final output image.

Next, the operation of the image processing apparatus 100 of the fourth embodiment will be described in detail. Incidentally, the image processing apparatus of the embodiment handles a color (R, G, B) image signal.

FIG. 23 is a flowchart showing a processing procedure of the image processing apparatus 100.

Hereinafter, the coordinate of a pixel of an image as two-dimensional data outputted from the image data input section 110 is denoted by (x, y). The luminance value of the pixel at the coordinate of (x, y) in the RGB space is denoted by I(x, y). In the case of a process in the R space, the luminance value is denoted by I_{R}(x, y). In the case of a process in the B space, the luminance value is denoted by I_{B}(x, y). In the case of a process in the G space, the luminance value is denoted by I_{G}(x, y).

At Act 01, the image processing apparatus 100 inputs the image data.

At Act 02, the brightness estimation section 101 obtains the brightness estimated value of a target pixel (x, y).

As a method of obtaining the brightness estimated value, there is a smoothing process. The smoothing process is the process of performing a convolution operation using a smoothing filter for each local region. As an example of the smoothing filter, a Gaussian filter represented by expression 1 can be mentioned.

$$G ( x , y ) = \frac{1}{2 π σ} {e}^{( - \frac{{x}^{2} + {y}^{2}}{2 {σ}^{2}} )} \qquad Expression 1$$

Where, x and y denote coordinates of an image, and σ denotes a Gaussian parameter.

A smoothed image can be obtained by performing the convolution operation of the Gaussian filter obtained by expression 1 and the input image.

When the brightness estimated value at the coordinate (x, y) in the RGB space is denoted by Ī(x, y), the smoothed image, that is, the brightness estimated value in the RGB space can be represented by expression 2.

$${\overline{I}}_{R} ( x , y ) = {\sum }_{y = 0}^{N - 1} {\sum }_{x = 0}^{N - 1} {I}_{R} ( x , y ) \times G ( x , y ) \\ {\overline{I}}_{G} ( x , y ) = {\sum }_{y = 0}^{N - 1} {\sum }_{x = 0}^{N - 1} {I}_{G} ( x , y ) \times G ( x , y ) \\ {\overline{I}}_{B} ( x , y ) = {\sum }_{y = 0}^{N - 1} {\sum }_{x = 0}^{N - 1} {I}_{B} ( x , y ) \times G ( x , y ) \qquad Expression 2$$

In addition to this, as a method of obtaining a smoothed image, there is a method in which a frequency analysis is performed and a low frequency band is used. As the frequency analysis method, there is an FFT (Fast Fourier Transform) or a DCT (Discrete Cosine Transform).

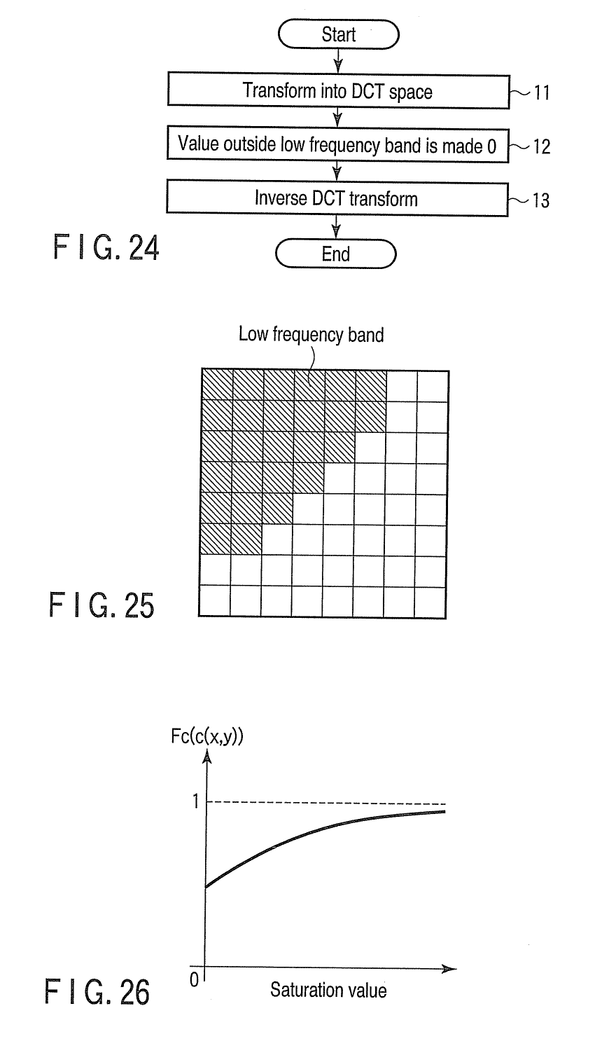

FIG. 24 is a flowchart showing a procedure to obtain the brightness estimated value by using the DCT.

At Act 11, the inputted image data is transformed into data in the DCT space. Expression 3 is a transform expression into the DCT space.

$$F ( u , v ) = \frac{2}{N} C ( u ) C ( v ) {\sum }_{y = 0}^{N - 1} {\sum }_{x = 0}^{N - 1} f ( x , y ) cos \{ \frac{2 x + 1}{2 N} u π \} cos \{ \frac{2 y + 1}{2 N} v π \} \qquad Expression 3$$

where,

N: size of window

$$C ( k ) \text{:} \{ \begin{matrix}\sqrt{\frac{1}{2}} & k = 0 \\ 1 & k \neq 0\end{matrix}$$

F(u,v): value after transform

f(x,y): value of input image.

At Act 12, a value outside the low frequency band is made 0, so that a value of the low frequency band in the DCT space is extracted.

FIG. 25 is view showing an example of the low frequency band when the DCT window is divided into 8×8 blocks.

The upper left point of the rectangle of FIG. 25 represents the origin. In the right direction, a frequency when a local image is scanned in the horizontal direction is divided into 8 bands from a low frequency to a high frequency. For example, a frequency when a horizontal-striped image is scanned is classified into the low frequency band, and a frequency when a vertical-striped image is scanned is classified into a high frequency band.

In the downward direction, a frequency when the local image is scanned in the vertical direction is divided into 8 bands from a low frequency to a high frequency. For example, a frequency when a vertical-striped image is scanned is classified into the low frequency band, and a frequency when a horizontal-striped image is scanned is classified into the high frequency band.

A band represented to be black in FIG. 25 represents the low frequency band selected in view of the frequency in the vertical direction and the frequency in the horizontal direction. Accordingly, in the bands shown in FIG. 25, when a value of the band represented to be white is made 0, the low frequency band can be extracted.

At Act 13 of FIG. 24, a smoothed image is obtained by inversely DCT-converting the value of the extracted low frequency band.

Expression 4 is an expression representing the inverse DCT transform.

$$f ( x , y ) = \frac{2}{N} {\sum }_{v = 0}^{N - 1} {\sum }_{u = 0}^{N - 1} C ( u ) C ( v ) F ( u , v ) cos \{ \frac{2 x + 1}{2 N} u π \} cos \{ \frac{2 y + 1}{2 N} v π \} \qquad Expression 4$$

At Act 03 of FIG. 23, the lightness correction section 102 executes a local γ correction. That is, the lightness correction section 102 uses the brightness estimated value obtained by the brightness estimation section 101, and executes the local lightness correction on the input image data. As an example of the correction method used here, there is a method disclosed in JP-A-2001-313844.

Expression 5 is an expression representing a local lightness correction value when a smoothed image is used as a brightness estimated value.

$${I}_{out} ( x , y ) = 255 \times {\{ \frac{{I}_{i n} ( x , y )}{255} \}}^{f ( \overline{I} )} \\ f ( \overline{I} ) = p 1 \times \overline{I} + p 2 \qquad Expression 5$$

where,

Ī: smoothed image

p1, p2: parameter

Iᵢₙ: input image

Iₒᵤₜ: output image.

Next, a correction effect is adjusted according to the saturation value based on the output result obtained by the local lightness correction.

At Act 04, the saturation value calculation section 104 obtains the saturation value of the target pixel (x, y). Expression 6 is an expression to represent a method of obtaining the saturation value.

C(x,y)=\sqrt{a(x,y)²+b(x,y)²} Expression 6

where,
C(x, y): saturation value
a(x, y): value of a in Lab space
b(x, y): value of b in Lab space.

Here, in expression 6, the saturation value is expressed using the values of a and b in the Lab space, and does not depend on the value of L. That is, a value on the L axis as the gray axis representing a=b=0 is not used in this saturation calculation. Accordingly, expression 6 is the expression to calculate, as the saturation value, the distance of the input image signal from the gray axis.

Incidentally, in addition to the method of using the values of a and b in the Lab space, CbCr values in the YCbCr space may be used.

At Act 05, the correction image adjusting section 103 uses the pixel value of the input image, the local lightness correction value and the saturation value, and calculates the final output image.

Expression 7 is an example of the expression to calculate the final output image.

I_{outR-c}(x,y)=Fc(C(x,y))×I_{R}(x,y)+(1.0−Fc(C(x,y))×IoutR(x,y)

I_{outG-c}(x,y)=Fc(C(x,y))×I_{G}(x,y)+(1.0−Fc(C(x,y))×IoutG(x,y)

I_{outB-c}(x,y)=Fc(C(x,y))×I_{B}(x,y)+(1.0−Fc(C(x,y))×Iout_{B}(x,y) Expression 7

Where, Fc(C(x,y)) is a function to determine the influence degree of the saturation value. In this embodiment, a sigmoid function represented by expression 8 is used.

$$Fc ( C ( x , y ) ) = \frac{1}{1 + {e}^{- ( K 1 \times C ( x , y ) + K 2 )}} \qquad Expression 8$$

where, K1: multiplication parameter constant, K2: addition parameter constant.

FIG. 26 is a view showing the characteristic of the sigmoid function. The sigmoid function indicates the characteristic of monotonically increasing a value of 0 to 1 as the saturation value increases. When the characteristic indicated by expression 8 is applied to expression 7, it is understood that the operation is as described below.

When the saturation value is low, the value of the sigmoid function is small. Accordingly, in the final output image represented by expression 7, the influence of the local lightness correction value is raised. On the other hand, when the saturation value is high, the value of the sigmoid function is large. Accordingly, in the final output image represented by expression 7, the influence of the local lightness correction value is suppressed to be low.

At Act 06, the image processing apparatus outputs the image data after the image process to the image data output section 120.

### Fifth Embodiment

An image processing apparatus of a fifth embodiment is different from the image processing apparatus of the fourth embodiment of handling the color image in that a luminance image is handled as an input image. Accordingly, the same portion as that of the fourth embodiment is denoted by the same symbol and its detail description is omitted.

Since a structure of an image processing system including the image processing apparatus of the fifth embodiment is the same as the structure shown in FIG. 22, its detailed description is omitted.

Next, the operation of the image processing apparatus 100 of the fifth embodiment will be described with reference to the processing procedure shown in FIG. 23. Incidentally, the image processing apparatus of this embodiment handles a luminance image signal.

Hereinafter, a coordinate of a pixel of an image as two-dimensional data outputted from an image data input section 110 is denoted by (x, y), and a luminance value of the pixel at the coordinate of (x, y) is denoted by I(x, y).

At Act 01, the image processing apparatus 100 inputs image data.

At Act 02, a brightness estimation section 101 obtains a brightness estimated value of a target pixel (x, y).

As a method of obtaining the brightness estimated value, a smoothing process can be mentioned. The smoothing process is the process of performing a convolution operation using a smoothing filter for each local region. As an example of the smoothing filter, a Gaussian filter represented by expression 9 can be mentioned.

$$G ( x , y ) = \frac{1}{2 π σ} {e}^{( - \frac{{x}^{2} + {y}^{2}}{2 {σ}^{2}} )} \qquad Expression 9$$

where, x and y denote coordinates of an image, and σ denotes a Gaussian parameter.

A smoothed image can be obtained by performing the convolution operation of the filter obtained by above expression and the input image.

When a brightness estimated value at the coordinate (x, y) in the RGB space is denoted by Ī(x, y), the smoothed image, that is, the brightness estimated value in the RGB space can be represented by expression 10.

$$\overline{I} ( x , y ) = {\sum }_{y = 0}^{N - 1} {\sum }_{x = 0}^{N - 1} I ( x , y ) \times G ( x , y ) \qquad Expression 10$$

In addition to this, as a method of obtaining the smoothed image, there is a method in which a frequency analysis is performed and a low frequency band is used. As the frequency analysis method, there is an FFT (Fast Fourier Transform) or a DCT (Discrete Cosine Transform). Since the flow showing a procedure of obtaining the brightness estimated value using the DCT is the same as that of FIG. 24, its detailed description is omitted.

At Act 03 of FIG. 23, a lightness correction section 102 executes a local γ correction. That is, the lightness correction section 102 uses the brightness estimated value obtained by the brightness estimation section 101 and executes the local lightness correction on the input image data.

Expression 11 is the expression to represent the local lightness correction value when the smoothed image is used as the brightness estimated value.

$${I}_{out} ( x , y ) = 255 \times {\{ \frac{{I}_{i n} ( x , y )}{255} \}}^{f ( \overline{I} )} \\ f ( \overline{I} ) = p 1 \times \overline{I} + p 2 \qquad Expression 11$$

where,
Ī: smoothed image
p1, p2: parameter
Iᵢₙ: input image
Iₒᵤₜ: output image.

Next, the correction effect is adjusted according to the saturation value based on the output result obtained by the local lightness correction.

At Act 04, a saturation value calculation section 104 obtains a saturation value of the target pixel (x, y). Expression 12 is the expression to represent the method of obtaining the saturation value.

C(x,y)=\sqrt{a(x,y)²+b(x,y)²} Expression 12

where,
C(x, y): saturation value
a(x, y): value of a in the Lab space
b(x, y): value of b in the Lab space.

Here, in expression 12, the saturation value is represented by using the values of a and b in the Lab space, and does not depend on the value of L. That is, the value on the L axis as the gray axis to represent a=b=0 is not used in this saturation calculation. Accordingly, it can be grasped that expression 12 is the expression to calculate, as the saturation value, the distance of the input image signal from the gray axis.

Incidentally, in addition to the method of using the values of a and b in the Lab space, CbCr values in the YCbCr space may be used.

At Act 05, the correction image adjusting section 103 uses the input image pixel value, the local lightness correction value and the saturation value, and calculates the final output image.

Expression 13 is an example of the expression to calculate the final output image.

I_{out-c}(x,y)=Fc(C(x,y))×I(x,y)+(1.0−Fc(C(x,y)))×Iₒᵤₜ(x,y) Expression 13

Here, Fc(C(x,y)) is the function to determine the influence degree of the saturation value. In this embodiment, the sigmoid function represented by expression 14 is used.

$$Fc ( C ( x , y ) ) = \frac{1}{1 + {e}^{- ( K 1 \times C ( x , y ) + K 2 )}} \qquad Expression 14$$

where, K1: magnification parameter constant, K2: addition parameter constant.

As described in the fourth embodiment, when the saturation value is low, the value of the sigmoid function is small. Accordingly, in the final output image represented by expression 13, the influence of the local lightness correction value is raised. On the other hand, when the saturation value is high, the value of the sigmoid function is large. Accordingly, in the final output image represented by expression 13, the influence of the local lightness correction value is suppressed to be low.

At Act 06, the image processing apparatus outputs the image data after the image processing to the image data output section 120.

### [Effects of the Fourth and Fifth Embodiments]

When the related art is used, the saturation of a region having a high saturation is reduced by the lightness correction, and for example, there can occur a phenomenon that an image becomes whitish. Since the region having high saturation is usually preferred by a person, when the image quality of the region is reduced, the evaluation of the correction is reduced.

According to the fourth and the fifth embodiments described above, the influence of the lightness correction process can be reduced for the region having high saturation.

Incidentally, in the fourth and the fifth embodiments, the sigmoid function, which is a monotonically increasing continuous function, is used as the function to determine the influence of the saturation value. Thus, the gradation from the region intensely subjected to the process to the region weakly subjected to the process can be smoothly changed. Incidentally, the function to determine the influence of the saturation value is not limited to the sigmoid function, but a monotonically increasing or decreasing continuous function can be used.

The image processing apparatus as described in the fourth and the fifth embodiments can be defined as follows.

### APPENDIX 1

An image processing apparatus includes a lightness correction section configured to correct lightness of an input image signal according to a feature of the input image signal, a saturation value calculation section configured to calculate a saturation value of the input image signal, and a correction image adjusting section configured to adjust a result calculated by the lightness correction section according to the saturation value.

### APPENDIX 2

An image processing apparatus includes a brightness estimation section configured to smooth an input image signal, a lightness correction section configured to calculate a correction result for each local portion based on the input image signal and a signal value calculated by the brightness estimation section, a saturation value calculation section configured to calculate a saturation value of the input image signal, and a correction image adjusting section configured to adjust, based on the saturation value, the result calculated by the lightness correction section.

### APPENDIX 3

An image processing apparatus includes a brightness estimation section configured to smooth an input image signal, a lightness correction section configured to calculate a correction result by generating an optimum tone curve for each local portion while the input image signal is made a base and an exponent of an exponential function and a signal value calculated by the brightness estimation section is made a variable of the exponent, a saturation value calculation section configured to calculate a saturation value of the input image signal, and a correction image adjusting section configured to adjust, based on the saturation value, the result calculated by the lightness correction section.

### APPENDIX 4

An image processing apparatus includes a lightness correction section configured to correct lightness of an input image signal according to a feature of the input image signal, a saturation value calculation section configured to calculate, as a saturation value, a distance of the input image signal from a gray axis, and a correction image adjusting section configured to adjust, based on the saturation value, a result calculated by the lightness correction section, causes a lightness correction effect to be reduced when the saturation value is high and causes the lightness correction effect to be raised when the saturation value is low.

### APPENDIX 5

A color image processing apparatus includes a brightness estimation section configured to smooth an input image signal, a lightness correction section configured to calculate a correction result for each local portion according to the input image signal and a signal value calculated by the brightness estimation section, a saturation value calculation section configured to calculate, as a saturation value, a distance of the input image signal from a gray axis, and a correction image adjusting section configured to adjust, based on the saturation value, the result calculated by the lightness correction section, causes a lightness correction effect to be reduced when the saturation value is high and causes the lightness correction effect to be raised when the saturation value is low.

### APPENDIX 6

An image processing apparatus includes a brightness estimation section configured to smooth an input image signal, a lightness correction section configured to calculate a correction result by generating an optimum tone curve for each local portion while the input image signal is made a base and an exponent of an exponential function and a signal value calculated by the brightness estimation section is made a variable of the exponent, a saturation value calculation section configured to calculate, as a saturation value, a distance of the input image signal from a gray axis, and a correction image adjusting section configured to adjust, based on the saturation value, the result calculated by the lightness correction section, causes a lightness correction effect to be reduced when the saturation value is high and causes the lightness correction effect to be raised when the saturation value is low.

### APPENDIX 7

In the appendix 4, 5 or 6, the correction image adjusting section adjusts, based on the saturation value, the result calculated by the lightness correction section by using a monotonically increasing or decreasing continuous function, causes the lightness correction effect to be reduced when the saturation value is high, and causes the lightness correction effect to be raised when the saturation value is low.

### APPENDIX 8

In the appendix 7, the monotonically increasing or decreasing continuous function is a sigmoid function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document processing apparatus which corrects object data included in a document, comprising:
a document file input section configured to input a document file including metadata and object data;
an object information acquisition section configured to acquire the object data from the document file;
a document information acquisition section configured to acquire the metadata added to the document;
a document information analysis section configured to execute, based on the metadata obtained by the document information acquisition section, at least one type of process application determination to determine whether a correction is applied or not applied to the object data;
an application process determination section configured to determine, based on a result of at least the one type of process application determination executed by the document information analysis section, whether the correction is applied or not applied to the object data; and
a process execution section configured to execute the correction on the object data based on a result determined by the application process determination section.

2. The apparatus according to claim 1, wherein the metadata used by the document information analysis section includes at least one of an attribute of the object data, a size and position information.

3. The apparatus according to claim 2, wherein when the attribute of the object data is a template, the document information analysis section determines that the correction is not applied to the object data.

4. The apparatus according to claim 2, wherein when the size of the object data is smaller than a first threshold or larger than a second threshold, the document information analysis section determines that the correction is not applied to the object data, and
the second threshold is larger than the first threshold.

5. The apparatus according to claim 2, wherein when the position information of the object data indicates that none of the object data exist within a set region, the document information analysis section determines that the correction is not applied to the object data.

6. The apparatus according to claim 1, wherein the application process determination section calculates results of a plurality of types of process application determination for each of the object data and determines whether the correction is applied or not applied.

7. The apparatus according to claim 6, wherein the calculation is one of a weighting calculation, a logical sum calculation and a logical product calculation.

8. The apparatus according to claim 1, further comprising a feature quantity calculation section configured to calculate a feature quantity of the object data and to determine whether an image quality correction is applied or not applied to the object data,
wherein when the feature quantity calculation section determines that the image quality correction is not applied to object data, the application determination section removes the object data from a target for which it is determined whether the correction is applied or not applied.

9. The apparatus according to claim 8, wherein the metadata used by the document information analysis section includes at least one of an attribute of the object data, a size and position information.

10. The apparatus according to claim 9, wherein when the attribute of the object data is a template, the document information analysis section determines that the correction is not applied to the object data.

11. The apparatus according to claim 9, wherein when the size of the object data is smaller than a first threshold or larger than a second threshold, the document information analysis section determines that the correction is not applied to the object data, and
the second threshold is larger than the first threshold.

12. The apparatus according to claim 9, wherein when the position information of the object data indicates that none of the object data exist within a set region, the document information analysis section determines that the correction is not applied to the object data.

13. The apparatus according to claim 8, wherein the application process determination section calculates results of a plurality of types of process application determination for each of the object data and determines whether the correction is applied or not applied.

14. The apparatus according to claim 13, wherein the calculation is one of a weighting calculation, a logical sum calculation and a logical product calculation.

15. The apparatus according to claim 1, further comprising a maintenance specifying section configured to specify object data which is not made a target of the correction,
wherein the application determination section removes the object data specified by the maintenance specifying section from a target for which whether the correction is applied or not applied is determined.

16. The apparatus according to claim 15, wherein the maintenance specifying section specifies, as the object data which is not made the target of the correction, at least one of an attribute of the object data, a size, position information and a color.

17. The apparatus according to claim 8, further comprising a maintenance specifying section configured to specify object data which is not made a target of correction,
wherein the application determination section removes the object data specified by the maintenance specifying section from a target for which whether the correction is applied or not applied is determined.

18. The apparatus according to claim 17, wherein the maintenance specifying section specifies, as the object data which is not made the target of the correction, at least one of an attribute of the object data, a size, position information and a color.

19. A document processing method for correcting object data included in a document, comprising:
inputting a document file including metadata and object data;
acquiring the object data from the document file;
acquiring the metadata added to the document;
executing, based on the obtained metadata, at least one type of process application determination to determine whether a correction is applied or not applied to the object data;
determining, based on a result of at least the one type of process application determination executed, whether the correction is applied or not applied to the object data; and
executing the correction on the object data based on a determined result.

20. The method of claim 19, further comprising:
calculating a feature quantity of the object data; and
determining whether an image quality correction is applied or not applied to the object data,
wherein when whether the correction is applied or not applied to the object data is determined, the object data for which that the image quality correction is not applied is determined based on the feature quantity, is removed from a target for which whether the correction is applied or not applied is determined.
